(19) United States
(12) Patent Application Publication
(10) Pub. No.: US 2002/0165789 A1
(43) Pub. Date: Nov. 7, 2002

(54) Product and service presentment and payment system for mobile e-commerce

(76) Inventors: Kenneth Paul Dudek, Rochester Hills, MI (US); David W. Dempsey, Highland, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 09/850,644

(22) Filed: May 4, 2001

(51) Int. Cl. G06F 17/60

(52) U.S. Cl. 705/26

(57) ABSTRACT

A vehicle communication system including a mobile application service provider communicating over a first wireless communication network, a mobile station communicating with the mobile application service provider via the first wireless communications network, and where the mobile station is capable of communicating with a merchant over a second wireless communication network to conduct electronic commerce.

### TECHNICAL FIELD

The present invention relates to the wireless transfer of data located on remote devices. More specifically, the present invention relates to a method and apparatus for conducting electronic commerce (e-commerce) from a vehicle, via a wireless communication system.

### BACKGROUND OF THE INVENTION

Electronic commerce is becoming increasingly important to merchants to generate sales and profits. Merchants desire automated methods to execute transactions to increase productivity and efficiency in the retail markets for products and services. An emerging market for e-commerce is in vehicle telematics. Operators of a vehicle desire to conduct purchases from the confines of their vehicle, eliminating awkward exchanges of cash such as in a drive-through service for a fast food restaurant, car wash, or other similar transaction. Employees of a merchant in a conventional vehicle transaction must tabulate the exchange of money, physically store the money, and in most cases make change for the operator of the vehicle. This money-handling process decreases productivity and throughput for the merchant, leading to the loss of potential sales and profits.

The development of wireless telecommunications has enabled the exchange of information that may be applied to the purchase of products or services from a vehicle. The present invention utilizes a wireless telecommunications/telematics system to transfer transaction or product and service data to and from a merchant and an operator of a vehicle, decreasing transaction time for the merchant and increasing sales capacity.

### SUMMARY OF THE INVENTION

In accordance with the teachings of the present invention, a method and apparatus is provided for using a wireless telecommunications/telematics system to transfer product and service information from a merchant to a vehicle operator and purchase requests from the vehicle operator. The merchant is equipped with a base station that preferably transmits and receives information over a near range wireless network. An embedded mobile station is installed in a vehicle to poll the near range wireless network to receive product and service information from the merchant and present this information in visual or audible form to the vehicle operator. The vehicle operator, using a visual, tactile, or voice interface to the embedded mobile station, may then generate purchase requests for the merchant's products or services.

In the method and apparatus of the present invention, the embedded mobile station may be equipped with a cellular phone, personal communication service (PCS) phone, radio transceiver, or satellite communication devices to communicate to a mobile application service center (MASC) such as utilized by the OnStar® service or a similar information system/provider. It should be understood that the MASC is used in the preferred embodiment of the present invention, but any centralized information service or computer system with wireless communication/telematics capabilities is considered within the scope of the present invention. The embedded mobile station is equipped with a global positioning system (GPS) receiver that can accurately determine the current position of the vehicle and may be used to verify purchase locations by the operator.

In one embodiment of the present invention, the embedded mobile station will communicate billing information directly to the MASC, and the MASC will communicate with a merchant bank such as a credit card company. The MASC will validate operator credit information with the merchant bank, eliminating the need for the merchant to communicate with the merchant bank. The MASC may pay the merchant directly and then generate a periodic consolidated bill for the operator of the vehicle such as a monthly bill containing all the purchases made by the vehicle operator using the vehicle telematics system and the service fees for the MASC provider. The present invention benefits the operator of the vehicle by allowing him/her to use the vehicle telematics system to purchase products and services in a simple manner without cash. The MASC consolidated billing process allows consumers to spend less time paying bills because they receive a single consolidated bill for the telematics system service fees and purchases executed through the telematics system. The present invention offers increased revenues to the MASC or vehicle telematics operator because of the ability to charge a handling fee for processing purchases made through the vehicle telematics system. The merchant benefits from the system because the merchant does not have to have or communicate with a merchant bank. In effect, the MASC is an intermediary between the merchant and the merchant bank.

### BRIEF DESCRIPTION OF THE DRAWINGS

The various advantages of the present invention will become apparent to one skilled in the art upon reading the following specification and by reference to the drawings in which:

FIG. 1 is a schematic diagram of a mobile application service network providing mobile application services to mobile stations in vehicles through a wireless telecommunications network and a near range wireless network;

FIG. 2 is a block diagram of a mobile station for use in the wireless networks of FIG. 1; and

FIG. 3 is a flowchart of the preferred method of the present invention for providing for the transmission of merchant product and service information to an operator of a vehicle for purchase.

### DESCRIPTION OF THE PREFERRED EMBODIMENT

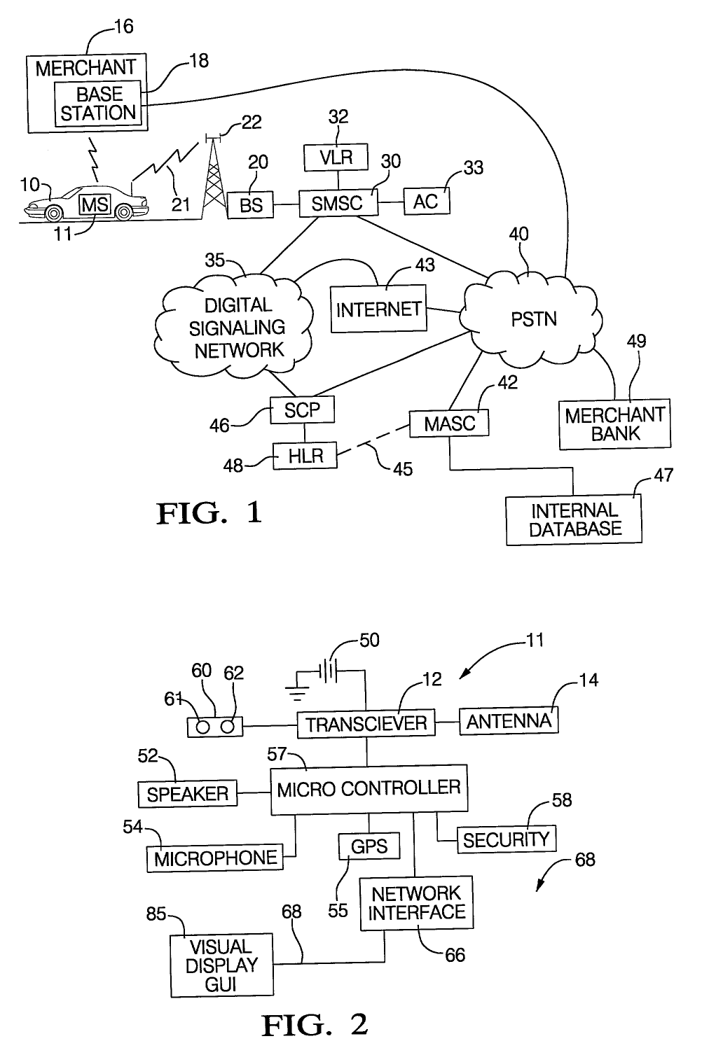

FIG. 1 shows a network model of a mobile application service network using a wireless telecommunications/telematics network and a near range wireless network. The model shows functional entities in a manner consistent with specification ANSI/TIA/EIA-41 (“IS-41”); the actual apparatus used is known to those skilled in the art, except as described herein.

Referring to FIG. 1, a vehicle 10 is mobile—either self-propelled (a motor vehicle) or propelled by another (a trailer). The vehicle 10 is provided with an embedded mobile station (MS) 11 capable of two-way communication via electromagnetic waves such as radio waves with a base station (BS) 20 (as used in a cellular communication system or personal communication services system), having an antenna 22, or linked to a satellite communication system. The MS 11 communicates with the BS 20 within a limited coverage area around the BS 20, as well as any other base stations as it moves through their limited coverage areas. When a satellite is used to communicate with the MS 11, the coverage area will vary to reflect the satellite coverage. The BS 20 is connected by land communication lines to a mobile switching center (MSC) which, because it is shown as currently serving MS 11, will be referred to as the serving mobile switching center (SMSC) 30.

The BS 20 (or satellite and satellite base station) and the SMSC 30 are operated by a wireless telecommunications service provider in a defined geographic service area. The SMSC 30 is part of a wireless telecommunications network providing mobile stations such as the MS 11 communication capability with other stations, either mobile or stationary. In the preferred embodiment, the MS 11, BS 20, and SMSC 30 preferably operate in the cellular license band, but they are not limited to such operation; the personal communications (PCS) band and others are alternatives.

In addition to the BS 20 and SMSC 30, the wireless telecommunications network comprises at least a digital signaling network 35 (ISDN, SS7, X-25) capable of carrying IS-41 data messages and a public switched telephone network (PSTN) 40 or wide-area network (WAN) capable of carrying voice and data transmissions. The digital signaling network 35 and PSTN 40 extend over a large geographical area (potentially all of North America or the globe) over which mobile application services are provided to moving vehicles. The SMSC 30 is further connected to a visitor location register (VLR) 32 containing temporary location, status, and service information concerning the MS 11 and other mobile stations registers as visitors with the SMSC 30. The SMSC 30 may optionally be connected to an authentication center (AC) 33 for performing authentication functions relative to mobile stations, including the MS 11, attempting access thereto.

The MS 11 is a subscriber to a mobile application service provider having a mobile application service center (MASC) 42 connected to the wireless telecommunications network via the PSTN 40. The mobile application service provider is a business concern that provides mobile application services to vehicles via the wireless telecommunications network. These mobile application services may include vehicle operator call-in services such as providing GPS-determined vehicle location data or providing data transfer such as downloading traffic, weather, or environmental data. The provider of these application services may or may not be also a provider of a telecommunications network in the network itself. In the preferred embodiment, the mobile application service provider is a manufacturer of vehicles and provides these services, as well as the embedded mobile station used in providing the data and services, to the purchaser and other operators of those vehicles. The MASC conducts standard credit card processing/authorization and communicates with a merchant bank 49 to authorize a transaction between a merchant 16 and the operator of the vehicle 10.

The MASC 42 is operated by the mobile application service provider and includes communications stations staffed by operators who receive calls to the MASC 42 from MS 11 and other mobile stations and/or automated computer systems which respond to calls from MS 11. The MASC 42 also communicates with government and emergency service providers, and any other similar brokers of information in order to provide the mobile application services requested or required by the operators and systems of the vehicle 10 and other vehicles having embedded mobile stations.

The MASC 42 also provides and maintains a home location register (HLR) 48 connected via a service control point (SCP) 46 to the digital signaling network 35 and the network PSTN 40. HLR 48 contains subscriber profile data for all embedded mobile stations, the data including such information as the MS 11 location, billing address, credit card numbers, subscriber status, call restrictions and directory numbers. If more than one physical home location register is provided, each one will contain the basic subscriber data, including call restrictions for all subscribers. A separate communication link, indicated by dashed line 45 in FIG. 1, may be provided between the HLR 48 and the MASC 42 to facilitate data flow in providing enhanced mobile application services.

The MS 11 further communicates with a merchant 16 having a near range wireless base station 18 over a near range wireless network 21. In the preferred embodiment of the present invention, the near range wireless base station 18 will broadcast product and service information over the near range wireless network 21 to be received by the MS 11. The near range wireless network 21 is preferably based on the Bluetooth® protocol, but any near range wireless network is within the scope of the present invention.

The MS 11 is shown with its vehicle interfaces in FIG. 2. The heart of the MS 11 is transceiver 12, which is manufactured by or to the specifications of the mobile application service provider and is provided by the mobile application service provider to be installed as an embedded unit within the vehicle 10. It may be installed by the mobile application service provider itself, by an automotive dealer, or by another installer on behalf of the mobile application service provider. The word “embedded” means that it is installed in the vehicle 10 and intended for use in the provision of application services provided to the vehicle 10, and further means that it is a subscriber of mobile application services provided. In the preferred embodiment, the transceiver 12 is technically capable of operation in a near range wireless network, the “A” or the “B” portions of the cellular band, and mobile stations using the PCS band and satellite transmissions are considered within the scope of the present invention. The mode, frequency, and power output of the transceiver 12 are determined by the operating mode. For example, the transceiver 12 may communicate over a near range wireless network and then be operated in the cellular or PCS bands by changing the frequency, amplitude and software protocol in the transceiver 12. In one embodiment of the present invention, the transceiver 12 will generally operate continuously as a near-range network node and then periodically operate as a cellular transceiver to upload and download information to and from the MASC 42.

The transceiver 12 is provided with identification data comprising a non-geographic, dialable, mobile identification number (MIN) and an equipment serial number (ESN), and this data is stored in the HLR 48 as part of its profile data.

The transceiver 12 is provided with electric power from a DC electric power supply 50, which may be the normal vehicle DC power supply or a supplemental DC power supply, and is connected by an RF connection to antenna 14. The antenna 14 is configured to transmit at several powers and frequencies depending on the operating mode of the transceiver 12. A control and interface microprocessor/microcontroller 57 provides interfacing and coordination with vehicle systems and accessories. For example, a visual display or graphical user interface (GUI) 85 communicates with the microcontroller 57 to provide visual information and tactile interaction with the transceiver 12. In other embodiments of the present invention, the microcontroller 57 may communicate over an automotive communications network 68 with accessories such as the GUI 85. In the preferred embodiment, the automotive communications network 68 is preferably GMLAN but may comprise any known automotive communications network.

The MS 11 further includes a tactile operator interface 60, a speaker 52, a microphone 54, and a security module 58. The tactile operator interface 60 includes buttons 61 and 62 that may be programmed for multiple functions including the execution of a purchase request. The speaker 52 may be used in conjunction with speech synthesizer software included with the microcontroller to present products and services information received by the MS 11 from the merchant base station 18 in audible fashion. Similarly, the GUI 85 may present product and service information received by the MS 11 from the merchant base station 18 in visual fashion. The security module 58 may use a smart card, biometric identification device, or any other device or method that can uniquely identify and authorize the user to make transactions using the vehicle telematics system.

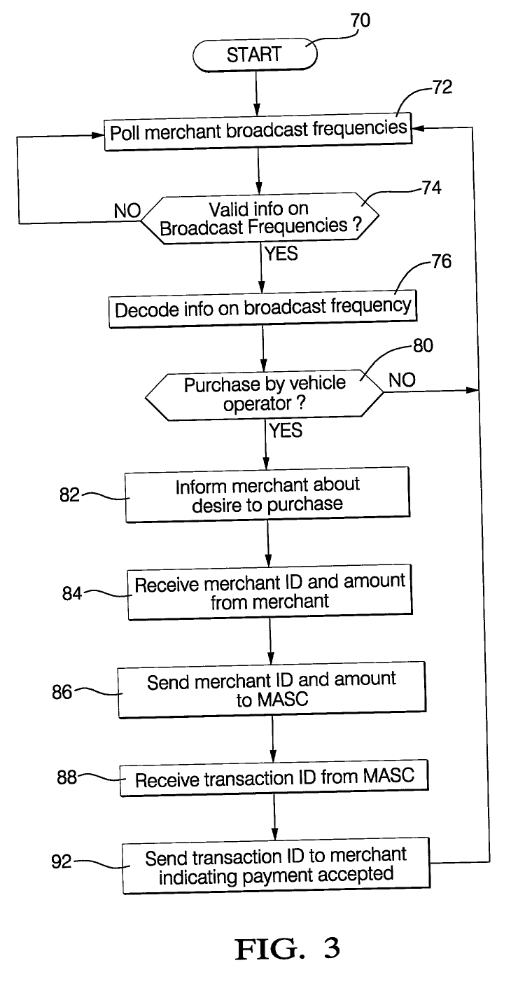

The preferred method of the present invention is illustrated in the flowchart of FIG. 3. Starting at block 70, the MS 11 is placed in an operating mode for communication over the near range wireless network 21. The communication protocol and power output are set by the microcontroller 57. At block 72, the MS 11 will poll the specific frequencies of the near range wireless network 21 to determine if a merchant 16 is in the vicinity of the vehicle 10. At block 74, the MS 11 will determine if valid product and service information is being broadcast over the near range wireless network 21. If valid product and service information is not present, then the routine will return to block 72 to continue polling the network 21. If valid product and service information is present, then the MS 11 will decode the product and service information at block 76 and present the products and services to the operator of the vehicle at block 78. The products and services may be presented to the operator in visual fashion over the GUI 85 or in audible fashion using the speaker 52.

The operator at block 80 will then determine if he/she desires to purchase a product or service from the merchant 16. If no purchase is desired by the operator, the routine will return to block 72. If a purchase is desired, the operator may use the buttons 61 and 62 of the tactile interface 60, a touch screen or mouse for the GUI 85, or speech recognition software and the microphone 54 to initiate a purchase request to the merchant 16. Products or services within the scope of the present invention include, but are not limited to, fast food purchases, car washes, tolls, oil changes, speeding tickets, or any other purchase which may be conducted by an operator of the vehicle 10.

At block 82, the MASC 42 will log the purchase by the operator of the vehicle 10 from the merchant 16. The merchant 16 has previously been assigned a transaction identification number that is stored in the MASC 42 to track purchases from the merchant 16. At block 82, the purchase request by the operator of the vehicle 10 is transmitted from the MS 11 to the base station 18 of the merchant 16 to inform the merchant 16 of a desire to purchase products or services. At block 84, the MS 11 receives the merchant 16 identification number and the cost of the product or service from the merchant. At block 86, the MS 11 transmits the merchant identification number and transaction amount to the MASC 42, where the MASC 42 will provide credit clearance for the purchase, via the merchant bank 49, and MS 11 credit information stored in the MASC. The MASC 42 generates a transaction identification number at block 88 and transmits the transaction identification number the MS 11. The merchant 16 receives the transaction identification number at the merchant base station 18 from the MS 11 at block 92, indicating that the payment has been accepted.

The MASC 42 will preferably pay the bill to the merchant 16 and generate a periodic billing statement to the operator of the vehicle 10 containing all purchases made by the operator via the MS 11 and the MASC service fees. The MASC 42 will further charge a handling fee for the processing of products and services made through the MS 11. The MASC 42 handles all credit transactions between the operator credit services and the merchant bank 49. The only thing the merchant 16 needs to execute a transaction is a merchant identification number and transaction identification number from the MASC 42. The MASC 42 handles the rest of the purchasing process, including paying the merchant 16 directly or arranging for payment via the merchant bank 49.

While this invention has been described in terms of some specific embodiments, it will be appreciated that other forms can readily be adapted by one skilled in the art. Accordingly, the scope of this invention is to be considered limited only by the following claims.

1. A vehicle communication system comprising:
a mobile application service provider communicating over a first wireless communication network;
a mobile station communicating with said mobile application service provider via said first wireless communications network;
wherein said mobile station is capable of communicating with a merchant over a second wireless communication network to conduct electronic commerce.

2. The vehicle communication system of claim 1 wherein said first wireless communication network is a cellular radio network.

3. The vehicle communication system of claim 1 wherein said second wireless communication network is a near-range wireless communication network.

4. The vehicle communication system of claim 1 wherein said near range wireless communication network is based on the Bluetooth communication protocol.

5. The communication system of claim 1 wherein said mobile station is embedded in a vehicle.

6. The communication system of claim 1 wherein said mobile station includes a graphical interface for an operator of a vehicle to view product information transmitted from said merchant to said mobile station.

7. The communication system of claim 1 wherein said mobile station includes a voice recognition apparatus.

8. The communication system of claim 1 wherein said mobile station includes a speech synthesizer.

9. The communication system of claim 1 wherein said mobile station is capable of full duplex communication with a merchant base station for an operator of a vehicle to conduct electronic commerce with said merchant.

10. The communication system of claim 1 wherein said mobile application service provider communicates with a merchant bank.

11. The communication system of claim 10 wherein said mobile application service provider authorizes transactions with said merchant through said merchant bank.

12. A method of conducting electronic commerce from a vehicle comprising the steps of;
receiving transmissions containing product information over a first wireless communication network from a merchant base station, said transmissions containing product information; and
presenting said product information to an operator of the vehicle.

13. The method of claim 12 wherein the step of receiving transmissions containing product information over a first wireless communication network comprises polling frequencies for a near range wireless communication network to determine if a merchant base station is present.

14. The method of claim 13 further comprising the step of decoding said product information from said received transmissions.

15. The method of claim 12 wherein the step of presenting said product information to said operator of the vehicle comprises presenting said product information in a graphical user interface.

16. The method of claim 12 wherein the step of presenting said product information to an operator of the vehicle comprises presenting said product information audibly using a speech synthesizer.

17. The method of claim 12 further comprising the step of said merchant base station receiving a response from said operator of the vehicle.

18. The method of claim 17 wherein the step of said merchant base station receiving a response from said operator comprises said merchant base station receiving a purchase request from said operator.

19. The method of claim 18 further comprising the steps of said merchant base station:
receiving a merchant identification number and a purchase amount from said merchant base station;
sending said merchant identification number and purchase amount to a mobile application service provider;
communicating with a merchant bank to verify the credit of said operator; and
sending a transaction identification number to said merchant base station to indicate payment has been accepted.

20. The method of claim 12 further comprising the steps of:
tracking a purchase by said operator from said merchant base station;
generating a bill for said operator; and
billing said operator periodically by a mobile application service provider.

21. A vehicle telematics system comprising:
a merchant base station;
a mobile station in a vehicle communicating with said merchant base station over a near range wireless communication network, said mobile station receiving product and service information from said merchant base station; and
a graphical user interface communicating with said mobile station for displaying said product and service information, said graphical user interface further allowing an operator of said vehicle to input purchase requests to said merchant base station.

22. The vehicle telematics system of claim 21 further including an audio interface communication with said mobile station for presenting product and service information in audible form.

23. The vehicle telematics system of claim 21 further comprising a mobile application service provider in communication with said mobile station.
